(19) United States
(12) Patent Application Publication
(10) Pub. No.: US 2016/0373913 A1
(43) Pub. Date: Dec. 22, 2016

(54) AUTOMATIC VEHICLE UPDATING VIA WIRELESS DEVICE

(71) Applicant: GM GLOBAL TECHNOLOGY OPERATIONS LLC, Detroit, MI (US)

(72) Inventors: JONATHAN R. SCHWARZ, LAKE ORION, MI (US); ROBERT A. HRABAK, WEST BLOOMFIELD, MI (US)

(21) Appl. No.: 14/742,401

(22) Filed: Jun. 17, 2015

(51) Int. Cl. H04W 8/00; G06F 9/445; H04L 29/08

(52) U.S. Cl. CPC H04W 8/005; H04L 67/34; H04L 67/12; G06F 8/65; G06F 8/61

(57) ABSTRACT

Methods, systems, and vehicles are provided for updating vehicles. A vehicle is located via a device that is disposed in proximity to the vehicle via a wireless search. A wireless connection is generated between the device and the vehicle. The wireless connection includes an assessment of an update required by the vehicle. The update is automatically, wirelessly provided from the device to the vehicle following the wireless connection.

### TECHNICAL FIELD

The present disclosure generally relates to vehicles, and more particularly relates to methods and systems for updating vehicles.

### BACKGROUND

Many vehicles require updates at one or more points in time, for example prior to purchase by an end user and/or during the life cycle of the vehicle after purchased by the end user. Typically, such updates are performed by various technicians who plug a computer system via a wired connection individually into each vehicle, and who then administer the update for the vehicle via the computer system. However, such existing techniques may not always be optimal, for example in situations in which multiple vehicles may require the updates.

Accordingly, it is desirable to provide improved techniques for updating vehicles. It is also desirable to provide methods, systems, and vehicles utilizing such techniques. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a method is provided. The method comprises locating a vehicle via a device disposed in proximity to the vehicle via a wireless search, generating a wireless connection between the device and the vehicle, the wireless connection including an assessment of an update required by the vehicle, and automatically, wirelessly providing the update from the device to the vehicle following the wireless connection.

In accordance with another exemplary embodiment, a vehicle is provided. The vehicle includes a transceiver, a memory, and a processor. The transceiver is configured to wirelessly communicate with a device disposed in proximity to the vehicle. The memory is configured to store an application that is configured to enable the vehicle to interface with the device via the transceiver, such that the vehicle is wirelessly located by the device, wirelessly associated with the device, and automatically, wirelessly provided with an update by the device following the wireless connection. The processor is configured to execute the application.

In accordance with a further exemplary embodiment, a system is provided. The system comprises a device comprising a transceiver, a memory, and a processor. The transceiver is configured to wirelessly communicate with a vehicle disposed in proximity to the device via a wireless search. The memory is configured to store an application that is configured to enable the device to interface with the vehicle via the transceiver, such that the device locates the vehicle, wirelessly associates with the vehicle, and automatically, wirelessly provides an update to the vehicle following the wireless connection. The processor is configured to execute the application.

### DESCRIPTION OF THE DRAWINGS

The present disclosure will hereinafter be described in conjunction with the following drawing figures, wherein like numerals denote like elements, and wherein:

FIG. 1 is a functional block diagram of a plurality of vehicles in a parking lot, along with a device that provides automatic updates for the plurality of vehicles, and depicted along with a remote server in communication with the device and/or the vehicles, in accordance with an exemplary embodiment; and

FIG. 2 is a flowchart of a process for updating vehicles, and that can be used in conjunction with the vehicles, the device, and/or the remote server of FIG. 1, in accordance with an exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

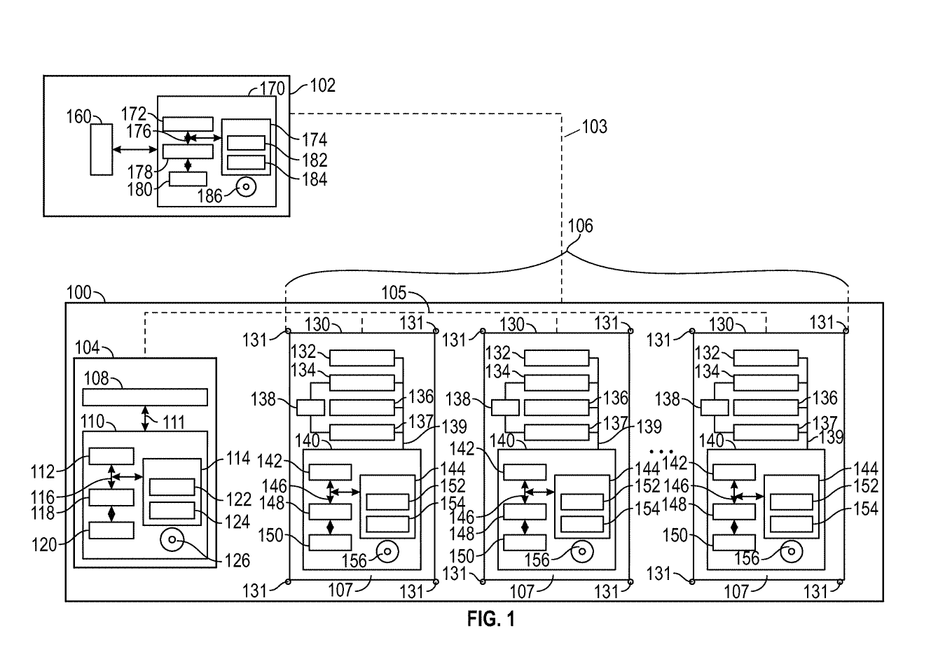

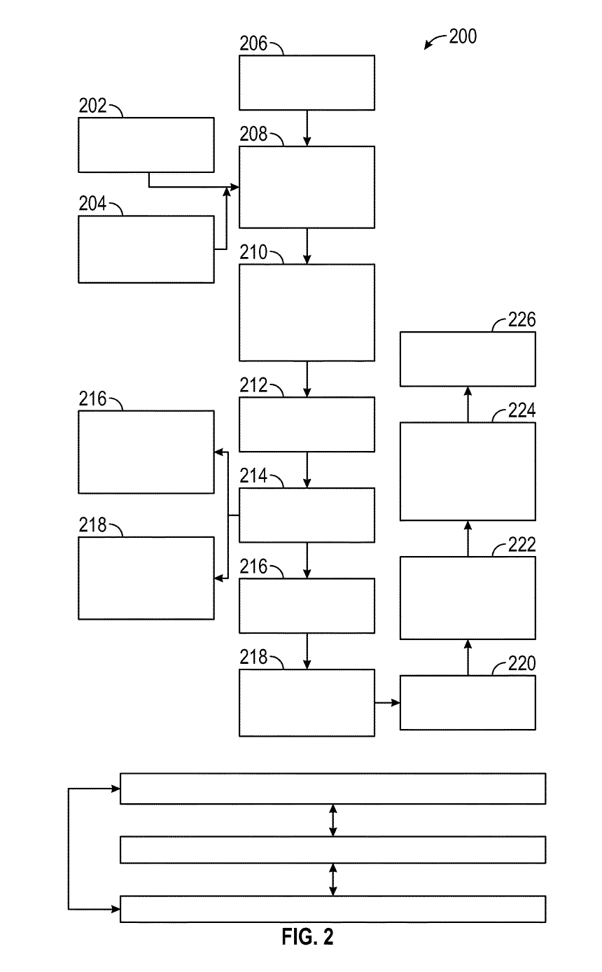

FIG. 1 depicts a vehicle parking lot 100, along with a remote server 102 and a communication network 103, in accordance with an exemplary embodiment. The parking lot 100 includes a device 104, a communication network 105, and a plurality (e.g. fleet) 106 of vehicles 107. As described in greater detail further below, the device 104 automatically provides updates to each of the vehicles 107 using the communication network 105, in accordance with the steps of the process 200 described further below in connection with FIG. 2, in accordance with an exemplary embodiment. In certain embodiments, the updates include software updates (or upgrades) for one or more vehicle modules that are automatically provided by the device 104 to the vehicle 107 and then installed by the vehicle 107 itself. Also as described in greater detail further below, in certain embodiments the remote server 102 is also utilized by the device 104 and/or the vehicles 107 in performing such functions.

In one exemplary embodiment, the plurality 106 of vehicles 107 comprises a number of vehicles of the same type and/or from the same manufacturer, and the parking lot is maintained or serviced by a manufacturer, dealer, and/or service center for the vehicles 107. In one such embodiment, the device 104 is utilized to provide updates to the vehicles 107 prior to purchase of the vehicles 107 by respective end users (e.g. on the premises of the manufacturer and/or dealer). In another embodiment, the device 104 may be used to update the vehicles 107 during servicing or maintenance, and/or when the vehicles 107 are parked within the parking lot 100 for any number of other reasons (e.g. when the end user is at work, shopping, running errands, or the like). In other embodiments, the plurality 106 of vehicles 107 comprises a fleet of vehicles (e.g. a fleet of taxi cabs, a fleet of delivery trucks, a fleet of school buses and/or commercial buses, or the like), and the fleet may likewise be updated by the device 104 while the vehicles 107 are being maintained or serviced, and/or are parked within the parking lot 100 for any number of other reasons (e.g. between shifts, or at the end of the business and/or school day or evening, or the like).

As depicted in FIG. 1, communication networks 103, 105 are both wireless networks. In one embodiment, the communication networks 103, 105 comprise, in whole or in part, the same wireless communication network. In various other embodiments, the communication networks 103, 105 of FIG. 1 comprise different wireless communication networks. For example, in one embodiment, communication network 103 comprises a long range wireless network (e.g. a satellite and/or cellular wireless network), while communication network 105 comprises a short range wireless network (e.g. a short range WiFi network and/or a short range wireless network using Bluetooth® technology).

Also as depicted in FIG. 1, the device 104 includes a transceiver 108 and a computer system 110. The transceiver 108 is configured to communicate with the plurality 106 of vehicles 107 via communication network 105. In certain embodiments, the transceiver 108 is also configured to communicate with the remote server 102 via communication network 103.

The computer system 110 is configured to provide instructions, implemented by the transceiver 108 (and, in certain embodiments, for implementation by the vehicles 107 and/or the remote server 102) for locating, associating with, and provided updates to each of the plurality 106 of vehicles 107. In the depicted embodiment, the computer system 110 includes a processor 112, a memory 114, an interface 118, a storage device 120, and a bus 116. The processor 112 performs the computation and control functions of the device 104, and may comprise any type of processor or multiple processors, single integrated circuits such as a microprocessor, or any suitable number of integrated circuit devices and/or circuit boards working in cooperation to accomplish the functions of a processing unit. During operation, the processor 112 executes one or more applications and/or programs (collectively referred to as applications) 122 contained within the memory 114 and, as such, controls the general operation of the device 104 and the computer system of the device 104, generally in executing the processes described herein, such as the process 200 described further below in connection with FIG. 2.

The memory 114 can be any type of suitable memory. For example, the memory 114 may include various types of dynamic random access memory (DRAM) such as SDRAM, the various types of static RAM (SRAM), and the various types of non-volatile memory (PROM, EPROM, and flash). In certain examples, the memory 114 is located on and/or co-located on the same computer chip as the processor 112. In the depicted embodiment, the memory 114 stores the above-referenced application 122 along with one or more stored values 124 (e.g., a stored information pertaining to the vehicles 107, the device 104, and/or required updates) for use in executing the functions of the device 104.

The bus 116 serves to transmit applications, programs, data, status and other information or signals between the various components of the computer system 110 of the device 104. The interface 118 allows communication to the computer system 110, for example from a system driver and/or another computer system, and can be implemented using any suitable method and apparatus. The interface 118 may also include one or more network interfaces to communicate with technicians, and/or one or more storage interfaces to connect to storage apparatuses, such as the storage device 120.

The storage device 120 can be any suitable type of storage apparatus, including direct access storage devices such as hard disk drives, flash systems, floppy disk drives and optical disk drives. In one exemplary embodiment, the storage device 120 comprises a program product from which memory 114 can receive an application 122 that executes one or more embodiments of one or more processes of the present disclosure, such as the steps of the process 200 (and any sub-processes thereof) described further below in connection with FIG. 2. In another exemplary embodiment, the program product may be directly stored in and/or otherwise accessed by the memory 114 and/or a disk (e.g., disk 126), such as that referenced below.

The bus 116 can be any suitable physical or logical means of connecting computer systems and components. This includes, but is not limited to, direct hard-wired connections, fiber optics, infrared and wireless bus technologies. During operation, the application 122 is stored in the memory 114 and executed by the processor 112.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the application (or program) and the instructions thereof and carry out the distribution thereof, such as a non-transitory computer readable medium bearing the application (or program) and containing computer instructions stored therein for causing a computer processor (such as the processor 112) to perform and execute the application (or program). Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system 110 may also otherwise differ from the embodiment depicted in FIG. 1, for example in that the computer system 110 may be coupled to or may otherwise utilize one or more remote computer systems and/or other control systems.

Also as depicted in FIG. 1, each of the vehicles 107 includes a body 130, four wheels 131, a transceiver 132, a propulsion system 134, an engine control system (ECS) 136, a plurality of modules 137, an rechargeable energy storage system (RESS) (e.g. a battery) 138, a communication unit 139, and a computer system 140. The body 130 is arranged on a chassis (not depicted in FIG. 1) and substantially encloses the other components of the vehicle 107. The body 130 and the chassis may jointly form a frame. The wheels 131 are each rotationally coupled to the chassis near a respective corner of the body 130. In various embodiments the vehicle 107 may differ from that depicted in FIG. 1. For example, in certain embodiments the number of wheels 131 may vary.

The propulsion system 134 is mounted on the chassis that drives the wheels 131. In one embodiment, the propulsion system 134 includes an engine, such as a combustion or diesel engine. In other embodiments, the propulsion system 134 may include one or more other types of engines and/or motors, such as an electric motor/generator, instead of or in addition to the combustion engine. In the depicted embodiment, the propulsion system 134 is controlled by the engine control system (ECS) 136.

Each of the modules 137 controls one or more functions of the vehicle 107. For example, in one embodiment, the modules 137 may include, among others, a steering module to control steering for the vehicle, a braking module to control braking for the vehicle, an environmental control module for controlling an environment (e.g., heating and cooling) for the vehicle 107, and an entertainment module for controlling entertainment (e.g., a radio, CD player, DVD player, and so on) for the vehicle 107. Also in one embodiment, various modules 137 may be coupled to the RESS 133.

Also in the depicted embodiment, the RESS 138 provides power for the functioning of the various modules 137. Also in the depicted embodiment, the RESS 138 is charged by the propulsion system 134 (e.g. by an engine thereof). In one embodiment, the RESS 138 comprises a twelve volt (12V) battery; however, this may vary in other embodiments.

The vehicle communication unit 139 communicatively couples various components of the vehicle 107, including the transceiver 132, the propulsion system 134, the ECS 136, the modules 137, the RESS 138, and the computer system 140. In one embodiment, the communication unit 139 comprises a vehicle CAN bus. However, in various embodiments, one or more other types of communication units 139 can be utilized. For example, in certain embodiments, the communication unit 139 may comprise one or more wired communication buses along with one or more wireless communication networks.

The computer system 140 is coupled to one or more of the other vehicle components (e.g., the transceiver 132, the propulsion system 134, the ECS 136, the modules 137, and the RESS 138) via the communication unit 139. The computer system 140 controls the functioning of the vehicle 107 and/or components thereof. Among other functions, the computer system 140 controls interactions of the vehicle 107 with the device 104 for the providing of updates from the device 104 to the vehicle 107, including via instructions provided to the transceiver 132 and the modules 137 in accordance with the steps of the process 200 described further below in connection with FIG. 1. Specifically, in accordance with an exemplary embodiment, the computer system 140 thereby assists with and facilitates the locating, associating with, and provided of updates from the device 104 to the vehicle 107. In certain embodiments, the computer system 140 also controls interactions with the remote server 102. In addition, in certain embodiments, the computer system 140 also provides controls and/or provides other functionality for various components of the vehicle 107 (e.g., the transceiver 132, the propulsion system 134, the ECS 136, the modules 137, and the RESS 138).

In the depicted embodiment, the computer system 140 includes a processor 142, a memory 144, an interface 148, a storage device 150 (e.g. disk 156), and a bus 146. The processor 142 performs the computation and control functions of the computer system 140 and, in one embodiment, for the vehicle 107. The processor 142 may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more applications and/or programs (collectively referred to as applications) 152 contained within the memory 144 and, as such, controls the general operation of the computer system 140 and the vehicle 107 in executing the processes described herein, such as the process 200 described further below in connection with FIG. 2.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144 stores the above-referenced application 152 along with one or more stored values 154 (e.g., a stored information pertaining to the vehicles 107, the device 104, and/or required updates) for use in executing the functions of the computer system 140 and the vehicle 107.

The bus 146 serves to transmit applications, programs, data, status and other information or signals between the various components of the computer system 140 of the vehicle 107. The interface 148 allows communication to the computer system 140, for example from a system driver and/or another computer system, and can be implemented using any suitable method and apparatus. The interface 148 can include one or more network interfaces to communicate with other systems or components. The interface 148 may also include one or more network interfaces to communicate with technicians, and/or one or more storage interfaces to connect to storage apparatuses, such as the storage device 150.

The storage device 150 can be any suitable type of storage apparatus, including direct access storage devices such as hard disk drives, flash systems, floppy disk drives and optical disk drives. In one exemplary embodiment, the storage device 150 comprises a program product from which memory 144 can receive an application 152 that executes one or more embodiments of one or more processes of the present disclosure, such as the steps of the process 200 (and any sub-processes thereof) described further below in connection with FIG. 2. In another exemplary embodiment, the program product may be directly stored in and/or otherwise accessed by the memory 144 and/or a disk (e.g., disk 156), such as that referenced below.

The bus 146 can be any suitable physical or logical means of connecting computer systems and components. This includes, but is not limited to, direct hard-wired connections, fiber optics, infrared and wireless bus technologies. During operation, the application 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the application (or program) and the instructions thereof and carry out the distribution thereof, such as a non-transitory computer readable medium bearing the application (or program) and containing computer instructions stored therein for causing a computer processor (such as the processor 142) to perform and execute the application (or program). Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system 140 may also otherwise differ from the embodiment depicted in FIG. 1, for example in that the computer system 140 may be coupled to or may otherwise utilize one or more remote computer systems and/or other control systems.

In certain embodiments, the device 104 and/or vehicles 107 communicate with the remote server 102 of FIG. 1 via the communication network 103. For example, in certain embodiments, the device 104 obtains the updates from the vehicles 107 from the remote server 102. By way of further example, in certain embodiments, the device 104 compares information provided by the vehicles 107 (e.g. identifying information regarding the vehicle 107 itself and the transceiver 132 of the vehicle 107) with information stored in a database of the remote server 102. By way of additional example, in certain embodiments, the vehicles 107 communicate with the remote server 102, for example by receiving the updates via the remote server 102 and/or by providing information for the remote server 102 to relay or convey to the device 104 (e.g. a notification that the update installation in the vehicle 107 has been completed). In certain embodiments, the remote server 102 is located in a different geographic location (e.g. a different city or state) than the parking lot 100, device 104, and vehicles 107 (e.g., in one embodiment, the remote server 102 comprises a remote call center).

In the depicted embodiment, the remote server 102 includes a transceiver 160 and a computer system 170. The transceiver 160 communicates with the device 104 and the vehicles 107 via the communication network 103, for example as discussed above (and, for example, to facilitate in providing updates and/or information between the device 104 and the vehicles 107). The computer system 170 is coupled to the transceiver 160. Among other functions, the computer system 170 controls interactions of the remote server 102 with the device 104 and the vehicles 107 (e.g., in facilitating the providing of updates and/or information between the device 104 and the vehicles 107).

In the depicted embodiment, the computer system 170 includes a processor 172, a memory 174, an interface 178, a storage device 180 (e.g. disk 186), and a bus 176. The processor 172 performs the computation and control functions of the computer system 170 and, in one embodiment, for the remote server 102. The processor 172 may comprise any type of processor or multiple processors, single integrated circuits such as a microprocessor, or any suitable number of integrated circuit devices and/or circuit boards working in cooperation to accomplish the functions of a processing unit. During operation, the processor 172 executes one or more programs 182 contained within the memory 174 and, as such, controls the general operation of the computer system 170 in executing one or more processes described herein, such as the process 200 described further below in connection with FIG. 2.

The memory 174 can be any type of suitable memory. For example, the memory 174 may include various types of dynamic random access memory (DRAM) such as SDRAM, the various types of static RAM (SRAM), and the various types of non-volatile memory (PROM, EPROM, and flash). In certain examples, the memory 174 is located on and/or co-located on the same computer chip as the processor 172. In the depicted embodiment, the memory 174 stores one or more programs 182 along with one or more stored values 184 (e.g., a the updates for the vehicles 107, along with stored information pertaining to the vehicles 107, the device 104, and/or required updates) for use in executing the functions of the computer system 170.

The bus 176 serves to transmit applications, programs, data, status and other information or signals between the various components of the computer system 170 of the vehicle 107. The interface 178 allows communication to the computer system 170, for example from a system driver and/or another computer system, and can be implemented using any suitable method and apparatus. The interface 178 can include one or more network interfaces to communicate with other systems or components. The interface 178 may also include one or more network interfaces to communicate with technicians, and/or one or more storage interfaces to connect to storage apparatuses, such as the storage device 180.

The storage device 180 can be any suitable type of storage apparatus, including direct access storage devices such as hard disk drives, flash systems, floppy disk drives and optical disk drives. In one exemplary embodiment, the storage device 180 comprises a program product from which memory 174 can receive a program 182 that executes one or more embodiments of one or more processes of the present disclosure, such as the steps of the process 200 (and any sub-processes thereof) described further below in connection with FIG. 2. In another exemplary embodiment, the program product may be directly stored in and/or otherwise accessed by the memory 174 and/or a disk (e.g., disk 186), such as that referenced below.

The bus 176 can be any suitable physical or logical means of connecting computer systems and components. This includes, but is not limited to, direct hard-wired connections, fiber optics, infrared and wireless bus technologies. During operation, the program 182 is stored in the memory 174 and executed by the processor 172.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the application (or program) and the instructions thereof and carry out the distribution thereof, such as a non-transitory computer readable medium bearing the application (or program) and containing computer instructions stored therein for causing a computer processor (such as the processor 172) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system 170 may also otherwise differ from the embodiment depicted in FIG. 1, for example in that the computer system 170 may be coupled to or may otherwise utilize one or more remote computer systems and/or other control systems.

FIG. 2 is a flowchart of a process 200 for updating vehicles, in accordance with an exemplary embodiment. The process 200 can be implemented in connection with the device 104, the vehicles 107, and the remote server 102 of FIG. 1, in accordance with certain embodiments. In one embodiment, the process 200 is performed by the device 104 of FIG. 1 separately, and simultaneously, with respect to each of the vehicles 107 in the parking lot 100 of FIG. 1.

As depicted in FIG. 2, the process 200 includes storing vehicle information (step 202). In one embodiment, the information for each vehicle 107 of the fleet 106 of FIG. 1 is stored within the corresponding vehicle 107. In one such embodiment, for each of the vehicles 107 of the fleet 106 of FIG. 1, corresponding vehicle information is stored in a corresponding memory 144 as stored values 154 thereof for the respective vehicle 107. Also in one embodiment, the vehicle information includes identifying information for both the vehicle 107 itself (e.g. a vehicle identification number (VIN)) as well as for the transceiver 132 of the respective vehicle 107 (e.g. a Bluetooth address (BD_Addr) for the transceiver 132). Also in one embodiment, the information is stored in the vehicle 107 in step 202 as part of a pre-loading of the application 152 for the vehicle 107. Also in one embodiment, the application 122 allows the vehicle 107 to interface with the device 104, including for allowing the vehicle 107 to be located by the device 104, associated with the device 104, and to be provided automatic updates from the device 104. In certain embodiments, certain of the vehicle information may be stored on the remote server 102 of FIG. 1, namely in the memory 174 thereof.

In addition, update information is stored (step 204). In one embodiment, the update information for each of the vehicles 107 in the fleet 106 is stored in the corresponding vehicle 106. In one such embodiment, for each of the vehicles 107 of the fleet 106 of FIG. 1, corresponding updated information is stored in a corresponding memory 144 as stored values 154 thereof for the respective vehicle 107. The update information may include, by way of example, a service database of vehicle part numbers that may be referred to in the vehicle updates. Also in one embodiment, the information is stored in the vehicle 107 in step 204 as part of a pre-loading of the application 152 for the vehicle 107. In certain embodiments, certain of the update information may be stored on the remote server 102 of FIG. 1, namely in the memory 174 thereof.

An application is also created and installed on the device (step 206). In one embodiment, the application 122 is installed in the memory 114 of the device 104 prior to any interaction with the vehicles 107. Also in one embodiment, the application 122 allows the device 104 to interface with the vehicles 107, including for the locating of the vehicles 107, the connection of the device 104 with the vehicles 107, and the automatic providing of updates to the vehicles 107.

In addition, various different types of information are stored on the device (step 208). In one embodiment, the stored information includes the vehicle-specific information from step 202 (e.g., including the identifying information for both the vehicle 107 itself as well as for the transceiver 132) for each of the vehicles 107 in the fleet 106, as well as the update information from step 204 (e.g., including the service database of vehicle part numbers that may be referred to in the vehicle updates). Also in one embodiment, the information is stored in the device in step 208 as part of the pre-loading of the application 122 for the device 104.

The device is located (or brought to a location) in proximity to the vehicles (step 210). In one embodiment, the device 104 of FIG. 1 is brought to the parking lot 100 of FIG. 1 to be in proximity to the vehicles 107 of the fleet 106 of FIG. 1. Also in one embodiment, during step 210 the device is placed in a “search for vehicle” mode, in which the transceiver 108 of the device 104 searches for the vehicles 107 via instructions provided by the processor 112.

The device then searches for vehicles while in the “search” mode (step 212). In one embodiment, the application 122, upon execution by the processor 112, searches for the vehicles 107 via the transceiver 108 using transceiver information searches for the transceivers 132 of the vehicles 107 (e.g., using BD_ADDR searches).

Once the vehicles are located by the device, a wireless connection occurs between the device and the vehicles (step 214). In one embodiment, the wireless connection takes place simultaneously between the device 104 and each of the vehicles 107 in the fleet 106 of FIG. 1 via the respective transceivers 108, 132 communicating via communication network 105, as directed by the respective applications 122, 152 upon execution by the respective processors 112, 142. In one embodiment, the connection occurs over a WiFi network (although in other embodiments other types of wireless networks may be utilized). Also in one embodiment, each of the vehicles 107 is “woken up”, but the respective RESSs (e.g. batteries) 138 are not turned on, thereby conserving energy. It will be appreciated that this and other steps may vary in different embodiments. For example, the process 200 may be used in a variety of different types of vehicles 107 including, without limitation, electric and/or fuel powered vehicles 107. By way of further example, the process 200 may be used in Wi-Fi and/or various other types of wireless networks. By way of additional example, in various embodiments, one or more simultaneous associations, serials associations, skewed associations (e.g. a simultaneous association with a time offset), and/or one or more other different types of wireless connections may be used as part of the wireless connection of step 214.

In certain embodiments, the vehicles 107 provide one or more notifications to aid in finding the vehicles 107 (steps 216, 218). For example, in one embodiment, one or both of the applications 122, 152 trigger the vehicle 107 to provide visual or sound indications within the parking lot 100 (e.g., honking of a horn and flashing of lights) that the vehicle 107 has been found (step 216). In another exemplary embodiment, one or both of the applications 122, 152 trigger the vehicle 107 to provide a notification (e.g. a text message or an e-mail message) to a user of the device 104 that the vehicle 107 has been found (step 218). In certain embodiments, the notifications are used to provide a supervisor individual or process a notification so that the supervisor individual or process identifies a change in state for the vehicles 107.

Also once the connection is completed, vehicle information is transferred to the device (step 220). In one embodiment, during step 220, information is transferred from each of the vehicles 107 of FIG. 1 to the device 104 of FIG. 1 as to updates (e.g. software or computer updates) required for the particular vehicle 107. Also in one embodiment, the vehicle information is transferred from the vehicles 107 to the device 104 via respective transceivers 108, 132 via wireless communication network 105 of FIG. 1 (e.g., via a WiFi connection). In certain embodiments, certain of the information may be transferred from the remote server 102 of FIG. 1 to the device 104 via the transceivers 160, 108 and wireless communication network 103.

Updates are provided to the vehicles (step 222). In one embodiment, the device 104 selects the appropriate updates needed by the different vehicles 107, and provides the corresponding required updates to the corresponding vehicles 107 via the respective transceivers such 108, 132 via wireless communication network 105 of FIG. 1 (e.g., via a WiFi connection). In one embodiment, the updates are stored in the memory 114 of the device 104, and the processor 112 of the device retrieves the updates from the memory 114 prior to transmission to the vehicle 107. In another embodiment, the updates are stored in the memory 174 of the remote server 102, and are transmitted from the remote server 102 to the device 104 (via transceivers 160, 108 along wireless communication network 103) prior to the transmission from the device 104 to the vehicle 107.

Commands are provided for performance of the updates (step 224), and the updates are performed within the vehicles (step 226). In one embodiment, the respective updates are performed within each of the corresponding vehicles 107 of FIG. 1 via one of the modules 137 of the respective vehicle 107 in response to commands and instructions provided by one or both of the applications 122, 152. Also in one embodiment, a radio module 137 of the vehicle 107 performs the update within the vehicle. However, this may vary in other embodiments.

In one embodiment, as part of step 226, each vehicle 107 maintains a status of the progress of the performance of the updates, and provides the status to the device 104. In one such embodiment, the status of the updates are maintained by the applications 152 of the corresponding vehicles 107 and provided to the application 122 of the device (for example, during the processing of the update) via transceivers 132, 108 along communication network 105. In one embodiment, the status is provided directly from the vehicles 107 to the device 104. In certain other embodiments, the status may be provided from the vehicles 107 to the remote server 102 and then to the device 104.

Upon completion of the performance of the update within the vehicle 107, a completion notice is similarly provided from the vehicle 107 to the device 104 (step 228). For example, in one embodiment, the completion notice is provided between the respective applications 152, 122 of the vehicles 107 and the device 104, utilizing the respective transceivers 132, 108 thereof and the wireless communication network 105). Similar to the discussion above, in one embodiment the completion notice is provided directly from the vehicles 107 to the device 104, while in certain other embodiments, the completion notice may be provided from the vehicles 107 to the remote server 102 and then to the device 104. In addition, in certain embodiments, an additional connection is performed between the vehicles 107 and the device 104 (similar to step 214 above).

Also in certain embodiments, a notification is then provided that the update has been successful (step 230). In one embodiment, the notification is provided by the vehicles 107 of FIG. 1 to the remote server 102 of FIG. 1 between transceivers 132, 160 along wireless communication network 103. In another embodiment, the notification is provided by the device 104 of FIG. 1 to the remote server 102 of FIG. 1 between transceivers 108, 160 along wireless communication network 103. In addition, in certain embodiments, the remote server 102 updates its databases (e.g. in the stored values 184 of the memory 174 of FIG. 1) accordingly for each of the vehicles 107.

Accordingly, the methods, systems, and vehicles discussed herein provide for potentially improved techniques for updating vehicles. For example, the methods, systems, and vehicles discussed herein can result in simultaneously updating multiple vehicles at the same time using the same device, and in an automatic fashion requiring potentially fewer resources and costs, and potentially less time, as compared with traditional techniques.

It will be appreciated that the disclosed methods, systems, and vehicles may vary from those depicted in the Figures and described herein. For example, the remote server 102, the device, the vehicles 107, the communication networks 103, 105, and/or various components thereof may vary from that depicted in FIG. 1 and described in connection therewith. In addition, it will be appreciated that certain steps of the process 200 may vary from those depicted in FIG. 2 and/or described above in connection therewith. It will similarly be appreciated that certain steps of the method described above may occur simultaneously or in a different order than that depicted in FIG. 2 and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

1. A method comprising:
locating a vehicle via a device disposed in proximity to the vehicle via a wireless search, utilizing a transceiver of the vehicle that is installed in the vehicle;
generating a wireless connection between the device and the transceiver of the vehicle, the wireless connection including an assessment of an update required by the vehicle; and
automatically, wirelessly providing the update from the device to the vehicle following the wireless connection via the transceiver of the vehicle.

2. The method of claim 1, further comprising:
pre-installing a first application in a memory of a computer system of the vehicle, the first application allowing the vehicle to be wirelessly located by the device, wirelessly associated with the device, and wirelessly updated by the device.

3. The method of claim 2, further comprising:
pre-installing a second application in a memory of the device, the second application allowing the device to wirelessly locate the vehicle, wirelessly associate with the vehicle, and wirelessly update the vehicle.

4. The method of claim 1, wherein the update is installed by the vehicle itself after the update is provided by the device to the vehicle via the transceiver of the vehicle.

5. The method of claim 1, wherein the vehicle is located, associated with the device, and automatically updated via the transceiver of the vehicle without having a vehicle ignition or vehicle battery being turned on.

6. The method of claim 1, wherein:
the step of locating the vehicle comprises locating a plurality of vehicles parked in a parking lot via the device, via the wireless search, via respective transceiver of the each of the vehicles, wherein the device is disposed in proximity to the plurality of vehicles;
the step of generating the wireless connection comprises generating a respective wireless connection between the device and each of the plurality of vehicles, each of the respective wireless connections including a respective assessment of a respective update required by a respective one of the plurality of vehicles; and
the step of providing the update comprises automatically, wirelessly providing the respective update from the device to each of the plurality of vehicles following the wireless connections.

7. The method of claim 6, wherein:
the step of locating the plurality of vehicles comprises simultaneously locating the plurality of vehicles via the device and via the respective transceivers of the vehicle;
the step of generating the respective wireless connections comprises generating the respective wireless connections simultaneously via the respective transceivers of the vehicle; and
the step of providing the respective corresponding updates comprises providing the respective corresponding updates simultaneously.

8. A vehicle comprising:
a transceiver installed as part of the vehicle, the transceiver configured to wirelessly communicate with a device disposed in proximity to the vehicle; and
a computer system installed as part of the vehicle, the computer system coupled to the transceiver of the vehicle, the computer system comprising:
a memory storing an application that is configured to enable the vehicle to interface with the device via the transceiver, such that the vehicle is wirelessly located by the device, wirelessly associated with the device, and automatically, wirelessly provided with an update by the device following the wireless connection between the device and the transceiver of the vehicle; and
a processor configured to execute the application.

9. The vehicle of claim 8, further comprising:
a module that is configured to install the update after the update is provided to the vehicle by the device.

10. The vehicle of claim 8, wherein the application enables the vehicle, upon execution of the application by the processor, to be located by the device, associated with the device, and automatically updated without having a vehicle ignition or vehicle battery being turned on.

11. The vehicle of claim 8, wherein the application includes identification numbers for the vehicle and for the transceiver stored in the memory of the vehicle, for use by the device in locating and associating with the vehicle.

12. The vehicle of claim 8, wherein the application enables the vehicle, upon execution of the application by the processor, to be located by the device, associated with the device, and updated by the device simultaneously with a locating, an associating, and an updating, by the device, of additional vehicles in proximity to the vehicle.

13. The vehicle of claim 8, wherein the processor is configured to notify the device, via the transceiver, when the update is complete.

14. The vehicle of claim 8, wherein the processor is configured to provide a visual notification for the device upon the vehicle being located by the device.

15.-20. (canceled)

21. A method comprising:
locating a vehicle that is parked among a plurality of vehicles that are parked in a parking lot, via a device that is disposed in proximity to the vehicle via a wireless search;
generating a wireless connection between the device and a transceiver of the vehicle that is installed within the vehicle as part of the vehicle, the wireless connection including an assessment of an update required by the vehicle; and
automatically, wirelessly providing the update from the device to the vehicle following the wireless connection via the transceiver of the vehicle.

22. The method of claim 21, wherein the plurality of vehicles comprises a fleet of vehicles that are parked together in the parking lot.

23. The method of claim 22, wherein the fleet of vehicles comprises the fleet of vehicles, each of a same vehicle type.

24. The method of claim 22, wherein the fleet of vehicles comprises the fleet of vehicles, each from a same vehicle manufacturer.

25. The method of claim 22, wherein the parking lot comprises a service center parking lot for the fleet of vehicles.

26. The method of claim 25, wherein each of the vehicles in the fleet are updated, separately and simultaneously, by the device while parked together in the service center parking lot.
